(19) United States
(12) Patent Application Publication
(10) Pub. No.: US 2014/0032322 A1
(43) Pub. Date: Jan. 30, 2014

(54) METHODS AND SYSTEMS FOR ON-SITE PROMOTION OF PRODUCTS

(71) Applicants: Marc Schwieger, Hamburg (DE); Sascha Rowold, Munich (DE); Christoph Hilberath, Konstanz (DE)

(72) Inventors: Marc Schwieger, Hamburg (DE); Sascha Rowold, Munich (DE); Christoph Hilberath, Konstanz (DE)

(21) Appl. No.: 13/559,410

(22) Filed: Jul. 26, 2012

(51) Int. Cl. G06Q 30/02

(52) U.S. Cl. 705/14.55

(57) ABSTRACT

Systems and methods for implementing digital promotions on mobile devices. A mobile device can receive and present various locations to a user where campaign providers are participating in promotional activities. The user may select a location and participate in a promotional action such as a sweepstakes on the mobile device at the selected location. Upon submitting the action, a digital promotion engine may process the action and/or send to the mobile device a promotional notification based on the action.

### BACKGROUND

Retail merchants often offer coupons, vouchers and other promotional sweepstakes to potential customers to entice them to visit the merchant's store and to attempt to increase purchase volume. Such merchants typically provide the coupons and vouchers in paper form and often do so through broad general advertisements. As a result of such broad and general promotions, many consumers fail to find value in the promotions since they may be looking for specific products that may not be subject to a promotion by the merchant at the time of the consumer's needs.

Mobile phones, and mobile access to the Internet, have also become increasingly popular. Smart phones, such as the iPhone, Android phones, Windows Phones, or Blackberry phones can operate in stores to provide additional digital access to online content and services.

Unfortunately, consumer have no current ability to digital identify interesting products and provide this preference to merchants in real-time. As a result, there is a need to provide for more real-time and on-site generation of coupons that are tied to specific desired products indicated by individual consumers. In this manner, the merchant has an incentive to provide a promotion since the consumer has indicated a higher interest level in such specific product.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### SUMMARY OF THE INVENTION

Described herein are systems and methods for implementing on-site promotions through a mobile device. A mobile device may display to a user a listing of campaign providers participating in promotional activities. A user may select a specific campaign provider and provide information, such as a photograph of a specific product, in order to request a promotion from the campaign provider. The campaign provider may implement a campaign that may provide a promotion to the user based on the user's request for a promotion. If issued a promotion, the user may redeem the promotion within a period of time at the selected campaign provider's premises.

### BRIEF DESCRIPTION OF THE DRAWINGS

Features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 is a block diagram illustrating a system that may be used to implement on-site promotions in an embodiment of the invention.

FIG. 2 is a block diagram illustrating in further detail a mobile device that may be used in the system of FIG. 1, according to an embodiment.

FIG. 3 is a flowchart illustrating an embodiment of a process for implementing on-site promotions according to an embodiment.

FIG. 4 illustrates an example of a listing of available campaign providers according to an embodiment.

FIG. 5 illustrates an example of a picture of a product that may be transmitted in accordance with an embodiment.

FIG. 6 illustrates an example of an on-site promotion notification response received in accordance with an embodiment.

FIG. 7 illustrates an example of an on-site promotion that may be redeemed in accordance with an embodiment.

FIG. 8 is a block diagram illustrating a computer system that may be used in an embodiment.

### DETAILED DESCRIPTION

In the following detailed description, numerous specific details are set forth in order to provide a thorough understanding of the invention. However, it will be understood by those of ordinary skill in the art that the invention may be practiced without these specific details. In other instances, well-known methods, procedures, components and circuits have not been described in detail so as not to obscure the invention. Various modifications to the described embodiments will be apparent to those with skill in the art, and the general principles defined herein may be applied to other embodiments. The invention is not intended to be limited to the particular embodiments shown and described.

Embodiments of the present invention are directed towards methods and systems that may provide on-site promotions to consumers through the use of a mobile device, by allowing consumers to identify desired products and allowing merchants to implement related promotions. In some embodiments, consumers may receive a promotion on the premises of a merchant via a mobile device or smart phone, such as an iPhone, Blackberry, Windows Phone, or Android mobile phone.

A promotion may be any discount, coupon, voucher, sweepstakes or other promotional campaign operated by a merchant or campaign provider. The discount value may form part of the promotion itself, or could be a variable or fixed discount percentage. For example, the promotion may be applied by reducing the final bill by a certain percentage or by a fixed value, or generating a credit that the user can redeem at a later date. In some embodiments, the promotion may involve the accumulation of loyalty points, which points may be specific to a merchant or may be aggregated across merchants. In some embodiments, the promotion may include additional or multiple items for free or at reduced cost.

In some embodiments, a campaign provider may be a physical retail storefront that has registered with the system to provide promotions to users. In an embodiment, a campaign provider may be a specific retail store location. In some embodiments, a campaign provider may be each of a plurality of stores operated by one or more retail merchants, regardless of the location of each store. In some embodiments, a campaign provider may include a retailer or other merchant not associated with any physical or storefront locations.

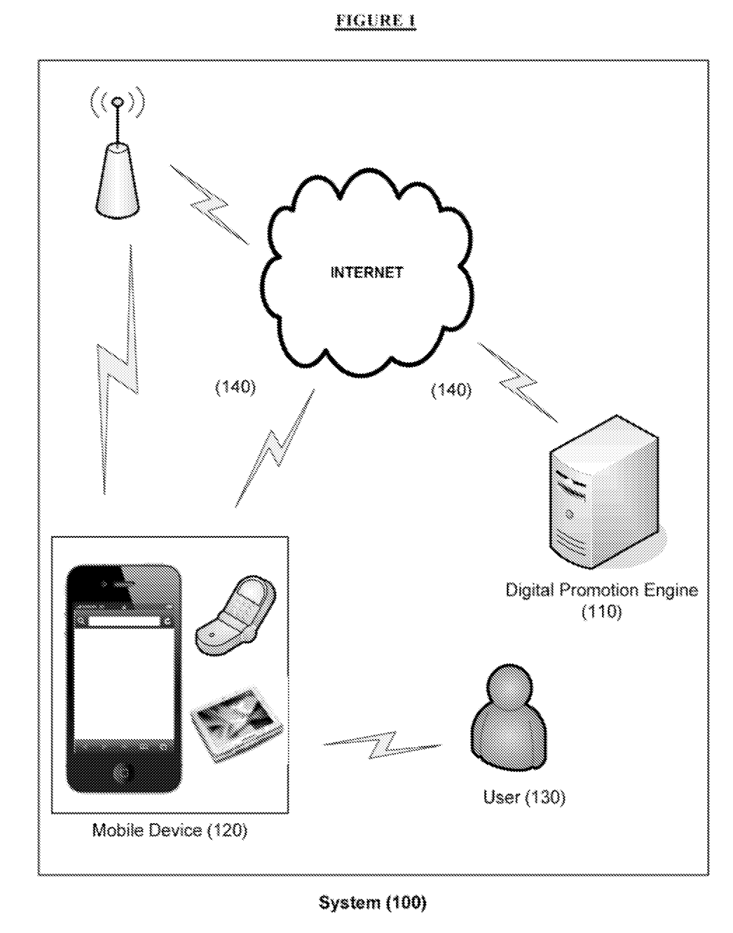

FIG. 1 is a block diagram illustrating an example of the architecture for the systems and methods described herein, according to an embodiment of the invention. The digital promotion engine (110) may maintain a listing of campaign providers, and may maintain associated retail locations for campaign providers, participating in on-site promotions as described herein. In an embodiment, the digital promotion engine (110) may be connected to one or more mobile devices (120) through a mobile communication network (140), such as the Internet. In alternate embodiments, the digital promotion engine (110) may communicate directly with the mobile devices (120). The one or more mobile devices (120) may receive a listing of one or more campaign providers from the digital promotion engine (110) and may permit the user (130) of the mobile device (120) to participate in an onsite promotion. The mobile device (120) may transmit information to the digital promotion engine (110) to indicate preference for one or more products of a campaign provider. The digital promotion engine (110) may be configured to process the information provided by the mobile device (120) in order to generate a digital promotion for transmission back to the mobile device (120).

The mobile devices (120) described herein may be any devices capable of communicating wirelessly with a computer network or other communication network, such as a tablet; personal digital assistants (PDAs) such as a Palm-based device or Windows CE device; or phones such as cellular phones or smartphones (e.g., iPhone, BlackBerry, Android, Treo). One or more of the devices may be handheld devices. Any discussion herein of mobile devices may also be applied to any other devices as provided.

Mobile device (120) may interact with the system (100) and communicate over networks (140) and to application servers via the Internet. The communication between a mobile device (120) and a network may be, for example, a connection between the device and a cellular network (140). One or more networks may communicate with one or more mobile devices across a particular network. For example, a plurality of devices may communicate with a single network, or with a plurality of networks. The network, for example, can include a private network, such as a LAN, or interconnections to the online organizations over a communications network, such as the Internet or World Wide Web or any other network that is capable of communicating digital data, such as a wireless, cellular, or telecommunications network. Each mobile device or other network device may connect to one or more application servers over the network using data protocols, such as HTTP, HTTPS and the like.

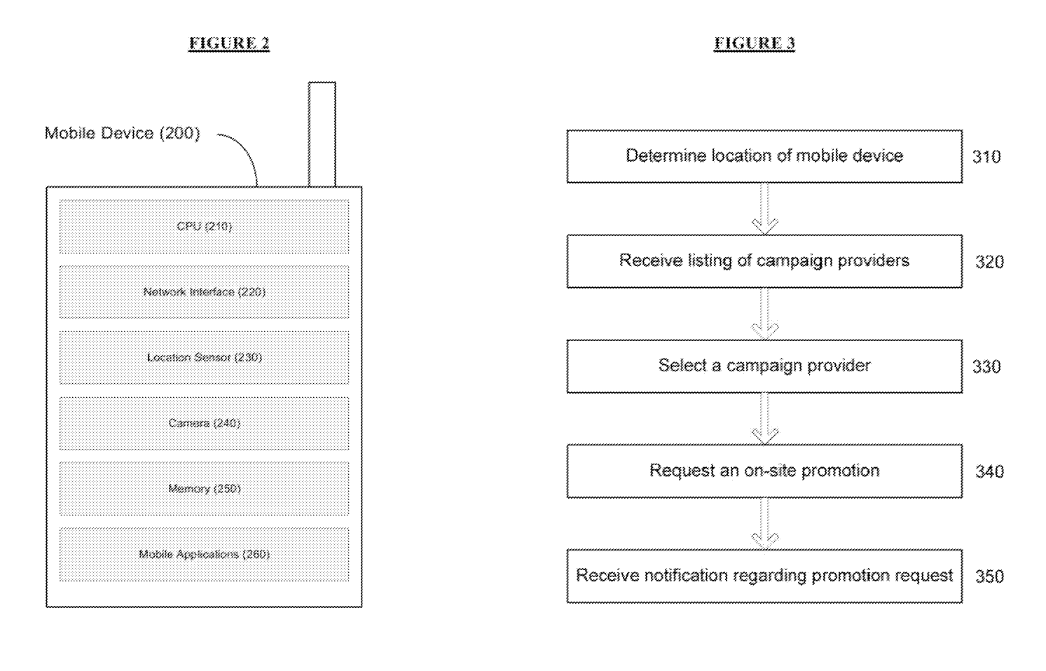

FIG. 2 is a block diagram illustrating in further detail an example of a mobile device (200) in accordance with an embodiment of the invention. For example, the mobile device (200) may be used in connection with system (100) as illustrated in FIG. 1. The mobile device (200) may have one or more memory (250) that may include non-transitory and/or tangible computer readable media which may contain instructions, logic, data, or code that may be stored in persistent or temporary memory of the device, or may somehow affect or initiate action by the device. The memory (250) may also include one or more databases. Mobile device (200) also includes one or more input and output devices, which may comprise one or more display devices including touch-screen displays that function as an input and output device. The mobile device (200) may include an accelerometer capable of detecting rotation or vibration of the mobile device (200).

Mobile device (200) may include a camera (240) capable of taking still or video pictures. In some embodiments, the memory (250) may store pictures taken with the camera (240) and may make available such pictures to mobile applications (260) installed on the mobile device (200). In some embodiments, mobile device (200) may include a location sensor (230), such as a GPS receiver.

In some embodiments, the mobile device (200) may implement the systems and methods described herein in connection with one or more mobile applications (260) residing in the memory (250) of the mobile device. For example, the memory (250) may store a mobile application that aids the user (130) in identifying a product for which the user (130) wishes to obtain an on-site promotion and which provides to the user (130) an on-site digital voucher or other promotion, in accordance with an embodiment.

The network interface (220) may be configured for wirelessly communicating with the mobile communication network. The network interface (220) may use any standard protocols for network communication. The network interface (220) may be capable of high speed, wireless network communication. In some embodiments, the network interface (220) may provide information to the location sensor (230) from which the location sensor (230) can infer or calculate a location of the mobile device (200).

FIG. 3 illustrates an example process for providing an on-site promotion. In some embodiments, the process described herein may be implemented in a mobile application stored on a mobile device. One or more steps may be performed by a processor. One or more steps may be performed in accordance with non-transitory computer readable media. For example, in an embodiment, the process described herein may be implemented using the mobile device (200) as illustrated in FIG. 2.

Referring to FIG. 3, at Step 310, a location of the mobile device (200) may be determined. In some embodiments, the mobile device (200) location may be determined by the location sensor (230) determining a geo-location, such as by use of GPS. In some embodiments, the location sensor (230) may use any other location information available to the mobile device (200) to determine its location, including for example based on the coordinates of one or more cellular towers used by mobile device (200). In some embodiments, the user (130) of mobile device (200) may manually provide location information, such as by entering the name or address of a particular store, landmark, or campaign provider.

Positional information regarding the current location of a mobile device may be obtained in any of various manners, according to various embodiments. For instance, mobile devices are increasingly required to provide Global Positioning Information, such as to support 911 and other emergency services. Thus, location sensor (230) on mobile device (200) may determine its current location using signals from Global Positioning Satellites, such as via the mobile device's normal wireless communication, such as via a network of communication towers, or such as mobile, cellular and/or satellite communication towers. Thus, in some embodiments, the location of a mobile device may be tracked via GPS data provided by the device itself.

Alternatively, the location of a mobile device (200) may be determined by cell-signal triangulation by the location sensor (230). As radio, wireless and cellular signal triangulation is well understood in the art, the details thereof will not be discussed herein. In general, any method of determining the location of mobile device may be used by the location sensor (230) to provide mobile device locations for use as described herein.

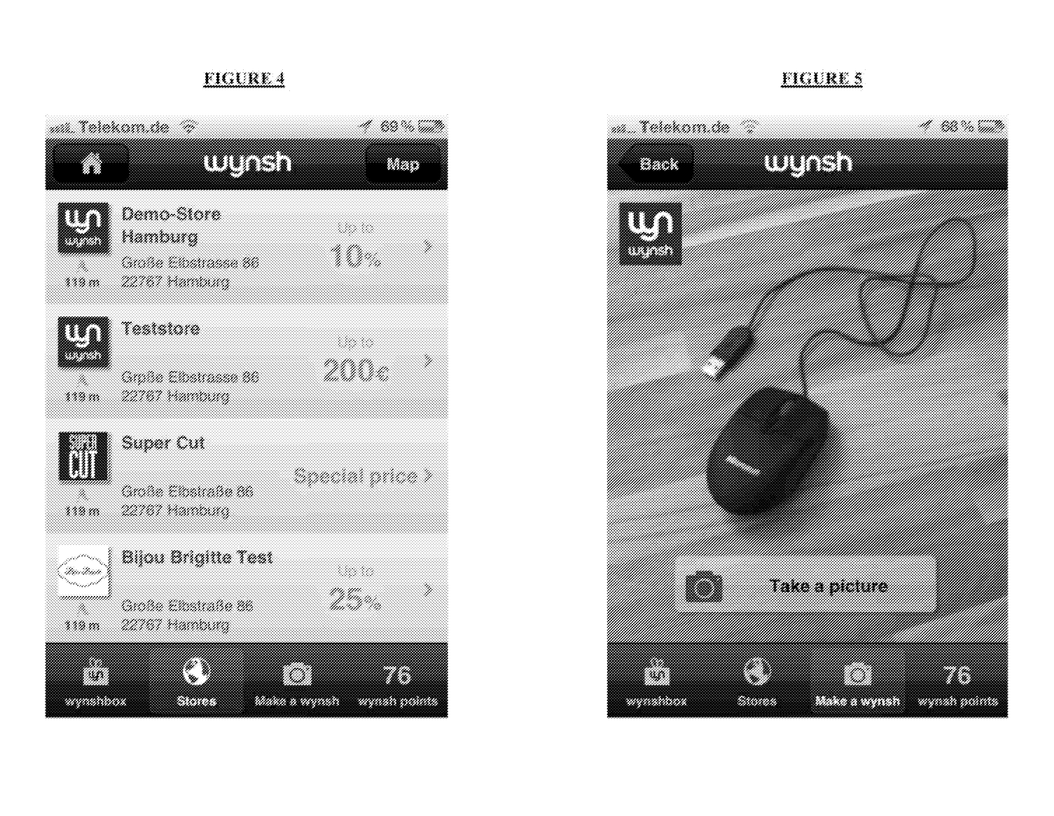

Referring to FIG. 3, at Step 320, a listing of campaign providers may be received by the mobile device (200) and displayed to the user (130). In some embodiments, as shown for example in FIG. 4, the campaign providers may be presented in a list format. In some embodiments, the campaign providers may be presented spatially on a map. In some embodiments, the campaign providers may be displayed on mobile phone (200) in a prioritized manner such that certain campaign providers may be more preferable to the user (130). For example, the campaign providers may be presented based on those campaign providers that are within a certain vicinity of the location of the user (130). The listing of campaign providers may be prioritized by the distance of each campaign provider relative to the location of the mobile device (200), as indicated by location sensor (230). For example, the listing of campaign providers may be prioritized by listing first the campaign provider that is closest in distance to the current location of mobile device (200), or by indicating on a visual map the location of mobile device (200) in addition to the locations of campaign providers. In some embodiments, the listing of campaign providers may be prioritized manually based on input from the user or based on frequency of requests by the user.

In some embodiments, the listing of campaign providers may include campaigns not associated with a physical storefront. In some embodiments, a campaign provider may create a campaign that is available to any mobile device (200) located within a particular geographic area. For example, a merchant may configure a campaign to be available to any mobile device that is located in a particular country or a particular city. In some embodiments, when a listing of campaign providers is received by mobile device (200), the listing may include a combination of campaign providers with physical storefronts and campaign providers not associated with a physical storefront.

Referring to FIG. 3, at Step 330, a campaign provider may be selected by the user (130). In one embodiment, the user (130) may select a campaign provider from the listing of campaign providers received by mobile device (200). For example, the user (130) may use an input device on mobile device (200) to select a specific campaign provider from the listing, such as by using a stylus or physically touching the desired campaign provider on a touch-screen input device on the mobile device (200) or by speaking a voice command to the mobile device (200) to so indicate a selection.

In some embodiments, a campaign provider may be selected automatically based on the location of the mobile device (200). The system (100) may track the location of mobile device (200) and may automatically select a campaign provider based on the current location of mobile device (200). For example, the system (100) may identify a current location of mobile device (200) which may be located within a vicinity of a campaign provider. At a different point in time, the system (100) may subsequently identify a new location of the mobile device (200) that may be located within a vicinity of an alternate campaign provider, and may automatically select the alternate campaign provider based on the updated location of mobile device (200).

In some embodiments, a campaign provider may be selected automatically by the use of two-way communication methods, such as near-field communication (“NFC”) technology. In one embodiment, a campaign provider may maintain an NFC receiver whereby the mobile device (200) may be recorded as entering the campaign provider's premises by the NFC receiver. For example, the mobile device (200) may contain a radio frequency identification (“RFID”) transmitter and the campaign provider main have an RFID receiver within its premises. In an embodiment, the user (130) of mobile device (200) may select the campaign provider by, for example, placing the RFID transmitter from the mobile device (200) on an RFID receiver made available by the campaign provider. The NFC technology may permit the mobile device (200) and campaign provider to identify each other without the need for entering any further information.

Referring to FIG. 3, at Step 340, the mobile device (200) may submit a request for an on-site promotion from the selected campaign provider. In some embodiments, the user (130) indicates a desire for a promotion by taking an action or providing an indicator to the merchant of his or her interest in receiving a promotion. For example, the user (130) may use the camera (240) on mobile device (200) to take a still or moving picture of a specific product that is available for sale at the selected campaign provider. In some embodiments, the picture may be stored in the memory (250) of the mobile device (200). In some embodiments, the picture may be stored at a remote storage location. A request for an on-site promotion may be submitted by transmitting the stored picture to the digital promotion engine (110).

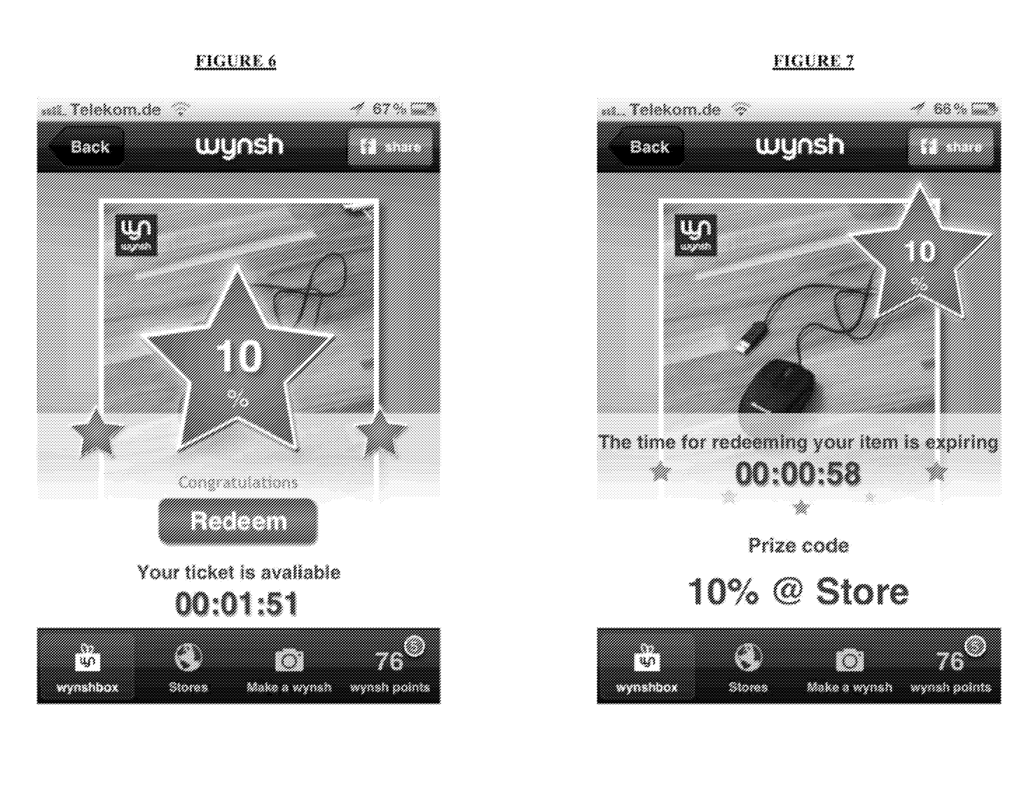

FIG. 5 illustrates a sample picture of a product that may be transmitted in accordance with an embodiment of the invention. The user (130) may take a picture of a specific computer mouse and transmit the picture to the digital promotion engine (110) in order to request a promotion for that particular model and brand of computer mouse.

In an embodiment, the user (130) may take a picture of more than one product and may store each such picture, such as for example in the memory (250) of mobile device (200). In an embodiment, one or more pictures of one or more products may be transmitted to digital promotion engine (110) in order to request a promotion for each such product. In some embodiments, only a subset of the product pictures taken at the selected campaign provider's premises may be transmitted to the digital promotion engine (110).

According to an embodiment, the timing of when a product picture is taken and when a request for promotion is submitted may span a period of time. In another embodiment, a picture of a product may be transmitted automatically as soon as picture of the product is taken.

In some embodiments, a request for an on-site promotion for a product may involve taking a picture of a product identifier. A product may have one or more associated identifiers, such as a Universal Product Code (“UPC”), a Stock-Keeping Unit (“SKU”), a Quick Response (“QR”) code, a barcode or other product identifier. For example, a manufacturer of a product may include a specific UPC on all packages of the manufacturer's product. In some embodiments, the UPC may be encoded as a barcode when included on product packaging or in a retail location. In some embodiments, the product identifier may be located on the product and a user (130) may take a picture of the product identifier by taking a picture of the product itself. In some embodiments, the product identifier may be located separately from the product such that a picture of the identifier may not include a picture of the product. For example, a campaign manager may place a single SKU code for each product on a shelf or other display apparatus where the product is stored. Accordingly, a picture of the SKU code may be taken and submitted in accordance with an embodiment without taking a picture of the product itself. In some embodiments, the digital promotion engine (110) may perform photo recognition of the object in the picture to identify the specific product.

In one aspect of the invention, a picture taken in accordance with the methods and systems described herein may include a “watermark” or other indicator for identifying the campaign provider from whom a promotion is requested. In an embodiment, the watermark may identify the campaign provider based on the specific location manually selected by the user. In an embodiment, the system may automatically identify the appropriate campaign provider or a specific location, such as for example based on information from location sensor (230). Accordingly, a campaign provider may identify that a picture of a specific product was taken at the campaign provider's location. In some embodiments, the watermark on the picture may be a visible logo, name or other discernible identifier of the store or merchant where the picture is taken. In some embodiments, the watermark on the picture may be a small amount of data included in a non-obvious location in the picture such that the watermark may be non-visible or otherwise “hidden” to the naked eye. In some embodiments, the watermark may be stored along with the metadata of the picture. In some embodiments, the watermark may be added to the picture within the application, and in other embodiments, the watermark may be merged into the picture on the server.

Referring to FIG. 3, at Step 350, mobile device (200) may receive a notification from the digital promotion engine (110) in response to a request for an on-site promotion, wherein the notification indicates whether a promotion has been issued by the campaign provider in response to the particular request. If a promotion is issued, the mobile device (200) may receive details as to the scope and type of promotion issued. In some embodiments, the promotion is tied directly to the product in the uploaded picture. For example, as illustrated in FIG. 6, in response to submitting a picture of a computer mouse as a request for a promotion, the campaign provider may issue a coupon for a 10% discount on the purchase of the computer mouse. The promotion notice may include information as to the product or products to which the discount is applicable and may include further information as to the terms and conditions of the promotion.

In one embodiment, an issued promotion may be time-limited. For example, a specific promotion notification may include notice of a period of time in which the promotion may be redeemed, such as for example requiring redemption of a discount coupon within 10 minutes from receipt of promotion notification. In this manner, a campaign manager can incentivize requests for promotions for desired products and user (130) may be more willing to purchase such desired products in the same visit. In some embodiments, the campaign provider may configure its various promotional campaigns in order to provide such time-limited features. In some embodiments, the promotion may be within certain time periods (e.g., X date to Y date).

An on-site promotion provided as described herein may be redeemed by presenting the promotion notification at the point-of-sale (“POS”). In one embodiment, an issued promotion may include a unique promotion identification number or code. The promotion may be verified by the merchant by validating the promotion identification number or code. In one embodiment, the promotion may be verified by showing the display of mobile phone (200) at the POS and verifying the promotion being redeemed by checking for a “watermark” indicating the promotion was based on a request submitted for that particular campaign provider.

In some embodiments, a promotion may include certain fraud protection mechanisms to help a merchant ensure that a promotion is not used more than once. For example, a time-limited voucher may include a second timer that further restricts use of the voucher during the redemption period after a short period of time.

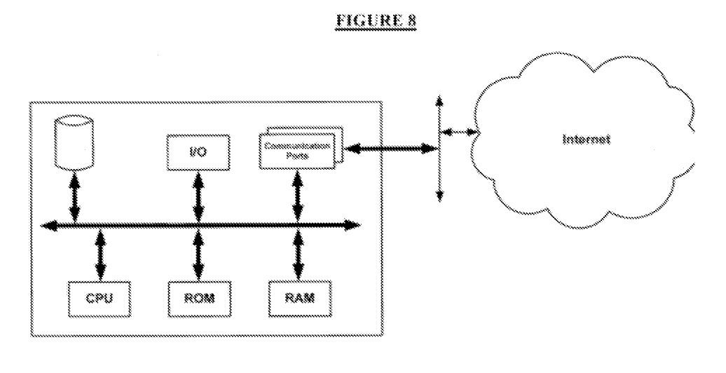

FIG. 7 illustrates an example of an on-site promotion that may be redeemed by presentation to a campaign provider at the POS. The campaign provider may verify the promotion by visually inspecting the displayed promotion for the “watermark” on the picture of the product, if visible, as well as by validating the “prize code” that may uniquely identify the promotion. The campaign provider may further verify that the promotion is still valid based on a timer indicating the amount of time remaining for redemption of such promotion.

Alternatively, the promotion could be automatically digitally accessed by POS equipment via a barcode scanner or other two-way communications path, such for example using NFC, Bluetooth, infrared or other communications standards. The digital promotion engine (110) may store a database of the identifiers of issued promotions, and the promotion stored on mobile device (200) may be validated by verifying that it is on the list of issued promotions.

Once the purchase transaction is completed, the database of issued promotions stored by the digital promotion engine (110) can be updated to indicate that the promotion has already been used, preventing the same promotion from being presented or redeemed more than once. In one embodiment, in the case that a two-way communications path (e.g., NFC, Bluetooth, infrared, etc.) is used to access the promotion digitally, the promotion may be deleted automatically from the memory of the mobile device (200) to prevent it from being reused.

Referring again to FIG. 1, the digital promotion engine (110) may store information about registered campaign providers and provide functionality for managing promotional campaigns. In one embodiment, the digital promotion engine receives a request from a mobile device (200) for a listing of active campaign providers. A campaign provider may create one or more active promotions using a variety of factors. For example, a campaign provider may indicate certain limits on a particular promotion, such as the number of promotions to issue per day or a total number of promotions to issue for a particular campaign. In some embodiments, a campaign provider may indicate limits on a per-user basis, such as, for example, setting a limit on the number of promotion requests from a single user on a per-hour or per-day basis.

In an embodiment, the digital promotion engine (110) may receive location information about the mobile device (200) in connection with a request for active campaigns. The digital promotion engine (110) may combine such location information with any other relevant information from user (130) or mobile device (200) in order to determine the appropriate listing of active campaigns to transmit back to the mobile device (200).

In one aspect of the invention, the digital promotion engine (110) may receive a request for an on-site promotion from mobile device (200). In one embodiment, the request may be accompanied by information about one or more products of interest to the user (130), such as a picture of a desired product.

In response to a request for a promotion, the digital promotion engine (110) may generate a promotion notification indicating whether the user (130) has been granted a promotion and, if so, under what terms and conditions. In an embodiment, the digital promotion engine (110) may determine whether to grant a promotion in response to a request based on a statistical algorithm structured to provide promotions on a proportionate basis. A campaign provider may create a promotion campaign such that a certain percentage of requests for promotions from users are successful. For example, a campaign may be registered such that the digital promotion engine (110) is instructed to grant a promotion to 50% of all requests for a promotion in connection with a particular campaign.

Upon a determination as to whether to grant a promotion in response to a request for a promotion, the digital promotion engine (110) may further determine the terms and conditions of a promotion. In some embodiments, the promotion terms may be a discount coupon and the digital promotion engine (110) may apply statistical algorithms to determine the discount applicable to each such promotion. For example, if a discount coupon will be transmitted to a mobile device (200), digital promotion engine (110) may further apply a percentage-weighted algorithm to determine the amount of discount percentage. In some embodiments, the discount amount or percentages may be pre-set by the campaign provider. In some embodiments, the discount amount may be fixed in time. In other embodiments, the discount amount may be generated by the digital promotion engine (110), based on a range indicated by the campaign provider.

A campaign may be configured such that, upon a determination to grant a promotion to user (130), the discount percentage for such promotion may be a range of percentages with weighted preference. For example, a campaign provider might indicate that any granted promotion in a particular campaign should provide a discount between 10%-50% for a single product, with a weighted preference of, for example, 0.75 for a 10% discount, 0.10 for a 20% discount, 0.10 for a 25% discount, and 0.05 for a 50% discount. The digital promotion engine (110) may apply such weighted preferences to the percentage discount range in order to determine the terms and conditions for a promotion for the user (130). In some embodiments, the campaign may be configured to permit the digital promotion engine (110) to generate more granular discount amounts based on a distribution model, such for example a normal distribution curve. Alternatively, a campaign may be registered to grant different promotions to different users. For example, a more loyal customer may get a deeper discount or higher promotion than a less loyal customer.

In some embodiments, a product picture submitted with a request for a promotion may be combined with other demographic information to determine a custom or targeted coupon or sweepstake to be presented to the user (130). For example, the digital promotion engine (110) may store certain demographic information about user (130) based on prior or alternate requests for promotions and may combine some demographic information with the campaign details in order to generate a custom promotion for user (130). In some embodiments, digital promotion engine (110) may access third party data, or data may be provided by the campaign provider, and such data may be included as demographic information to determine a promotion.

In some embodiments, the digital promotion engine (110) may generate a promotion for products related to the product desired by the user (130). In response to a picture of a product received from mobile device (200), the digital promotion engine (110) may identify products related to the product in the picture. The campaign provider may create certain campaigns in which a promotion notification is generated based on products related to the requested product. In some embodiments, the digital promotion engine (110) may generate a promotion with differing discounts based on the product chosen, such as providing a higher discount on shoes and a lower discount on jeans.

Referring to FIG. 8, the systems and methods described herein may be implemented in or upon computer systems, such as the computer systems shown in FIG. 8. For example, the digital promotion engine (110) shown in FIG. 1 may be implemented in or upon such computer systems. Such computer systems may include various combinations of central processor or other processing device, an internal communication bus, various types of memory or storage media (RAM, ROM, EEPROM, cache memory, disk drives etc.) for code and data storage, and one or more network interface cards or ports for communication purposes. The systems and methods described herein may include or be implemented in software code, which may run on such computer systems or other systems. During operation, the code may be stored within the computer system. At other times, the code may be stored at other locations and/or transmitted for loading into the appropriate computer system. Execution of the code by a processor of the computer system may enable the computer system to implement the methods and systems described herein.

FIG. 8 provides an example illustration of a functional block diagram of a computer hardware platform, in or upon which the systems and methods described herein may be implemented (for example the digital promotion engine (110) of FIG. 1). FIG. 8 shows an example of a network or host computer platform, as may be used to implement a server, according to an embodiment.

The computer system of FIG. 8 may communicate with other systems through a computer network. The systems and methods described herein may be implemented in or upon such computer hardware platforms in whole, in part, or in combination. For example, aspects of the systems and methods described herein involving transmission or other sharing of data between systems may be implemented on systems such as the server of FIG. 8. The systems and methods described herein, however, are not limited to use in such systems and may be implemented or used in connection with other systems, hardware or architectures. The methods described herein may be implemented in computer software that may be stored in the computer systems and servers described herein.

A computer system or server, according to various embodiments, may include a data communication interface for packet data communication. The computer system or server may also include a central processing unit (CPU), in the form of one or more processors, for executing program instructions. The computer system or server may include an internal communication bus, program storage and data storage for various data files to be processed and/or communicated by the server, although the computer system or server may receive programming and data via network communications. The computer system or server may include various hardware elements, operating systems and programming languages. The server or computing functions may be implemented in various distributed fashions, such as on a number of similar or other platforms. The computer system may also include input and output (I/O) devices such as a mouse, game input device or controller, display, touch screen or other I/O device or devices in various combinations.

The systems and methods described herein may be implemented in mobile devices such as mobile phones, mobile tablets and other mobile devices with various communication capabilities including wireless communications, which may include radio frequency transmission, infrared transmission or other communication technology. Thus, the hardware described herein may include transmitters and receivers for radio and/or other communication technology and/or interfaces to couple to and communication with communication networks.

The methods described herein may be implemented in computer software that may be stored in the computer systems, including a plurality of computer systems and servers, or the mobile devices. These may be coupled over computer networks including the Internet. Accordingly, an embodiment includes a network, including the various system and devices coupled with the network.

Further, various methods and architectures as described herein, such as the various processes described herein or other processes or architectures, may be implemented in resources including computer software such as computer executable code embodied in a computer readable medium, or in electrical circuitry, or in combinations of computer software and electronic circuitry.

Aspects of the systems and methods described herein may be implemented as functionality programmed into any of a variety of circuitry, including programmable logic devices (PLDs), such as field programmable gate arrays (FPGAs), programmable array logic (PAL) devices, electrically programmable logic and memory devices and standard cell-based devices, as well as application specific integrated circuits (ASICs). Some other possibilities for implementing aspects of the systems and methods include: microcontrollers with memory, embedded microprocessors, firmware, software, etc. Furthermore, aspects of the systems and methods may be embodied in microprocessors having software-based circuit emulation, discrete logic (sequential and combinatorial), custom devices, fuzzy (neural network) logic, quantum devices, and hybrids of any of the above device types. Of course, the underlying device technologies may be provided in a variety of component types, e.g., metal-oxide semiconductor field-effect transistor (MOSFET) technologies like complementary metal-oxide semiconductor (CMOS), bipolar technologies like emitter-coupled logic (ECL), polymer technologies (e.g., silicon-conjugated polymer and metal-conjugated polymer-metal structures), mixed analog and digital, etc.

It should be noted that the various functions or processes disclosed herein may be described as data and/or instructions embodied in various computer-readable media, in terms of their behavioral, register transfer, logic component, transistor, layout geometries, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, email, etc.) over the Internet and/or other computer networks via one or more data transfer protocols (e.g., HTTP, FTP, SMTP, etc.). When received within a computer system via one or more computer-readable media, such data and/or instruction-based expressions of components and/or processes under the systems and methods may be processed by a processing entity (e.g., one or more processors) within the computer system in conjunction with execution of one or more other computer programs.

Unless specifically stated otherwise, as apparent from the following discussions, it is appreciated that throughout the specification, discussions utilizing terms such as “processing,” “computing,” “calculating,” “determining,” or the like, may refer in whole or in part to the action and/or processes of a processor, computer or computing system, or similar electronic computing device, that manipulate and/or transform data represented as physical, such as electronic, quantities within the system's registers and/or memories into other data similarly represented as physical quantities within the system's memories, registers or other such information storage, transmission or display devices. It will also be appreciated by persons skilled in the art that the term “users” referred to herein can be individuals as well as corporations and other legal entities. Furthermore, the processes presented herein are not inherently related to any particular computer, processing device, article or other apparatus. An example of a structure for a variety of these systems will appear from the description herein. In addition, embodiments of the invention are not described with reference to any particular processor, programming language, machine code, etc. It will be appreciated that a variety of programming languages, machine codes, etc. may be used to implement the teachings of the invention as described herein.

Unless the context clearly requires otherwise, throughout the description and the claims, the words ‘comprise,’ ‘comprising,’ and the like are to be construed in an inclusive sense as opposed to an exclusive or exhaustive sense; that is to say, in a sense of ‘including, but not limited to.’Words using the singular or plural number also include the plural or singular number respectively. Additionally, the words ‘herein,’ ‘hereunder,’ ‘above,’ ‘below,’ and words of similar import refer to this application as a whole and not to any particular portions of this application. When the word ‘or’ is used in reference to a list of two or more items, that word covers all of the following interpretations of the word: any one or more of the items in the list, all of the items in the list and any combination of the items in the list.

The above description of illustrated embodiments of the systems and methods is not intended to be exhaustive or to limit the systems and methods to the precise form disclosed. While specific embodiments of, and examples for, the systems and methods are described herein for illustrative purposes, various equivalent modifications are possible within the scope of the systems and methods, as those skilled in the relevant art will recognize. The teachings of the systems and methods provided herein can be applied to other processing systems and methods, not only for the systems and methods described above.

The elements and acts of the various embodiments described above can be combined to provide further embodiments. These and other changes can be made to the systems and methods in light of the above detailed description. Without limitation, features described may be combined with various systems, methods and products described. Without limitation, multiple dependent claims may be made based on the description herein.

In general, in the following claims, the terms used should not be construed to limit the systems and methods to the specific embodiments disclosed in the specification and the claims, but should be construed to include all processing systems that operate under the claims.

While certain aspects of the systems and methods are presented below in certain claim forms, the inventors contemplate the various aspects of the systems and methods in any number of claim forms. Accordingly, the inventors reserve the right to add additional claims after filing the application to pursue such additional claim forms for other aspects of the systems and methods.

What is claimed is:

1. A computer-implemented method for implementing digital promotions on a mobile device, comprising:
receiving on the mobile device a plurality of locations of campaign providers that are participating in one or more promotional activities;
presenting to a user of the mobile device the plurality of locations of campaign providers;
selecting, using a processor, a location from the plurality of locations of campaign providers;
recording an action on the mobile device at the selected location;
submitting the recorded action to a digital promotion engine capable of processing the action;
receiving at the mobile device a promotional notification from the digital promotion engine based on the recorded action.

2. The method of claim 1, wherein one or more locations from the plurality of locations of campaign providers is based on the location of the mobile device.

3. The method of claim 1, wherein the plurality of locations of campaign providers are presented to the user on an electronic map indicating the relative position of the campaign providers.

4. The method of claim 1, wherein the promotional notification is a digital coupon for use at the selected location.

5. The method of claim 1, wherein the promotional notification involves a loyalty points program.

6. The method of claim 1, wherein the action on the mobile device is to take a picture of a product available for sale at the selected location.

7. The method of claim 1, wherein the action on the mobile device is the mobile device physically entering the premises of the selected location.

8. A computer-implemented method for implementing digital promotions, comprising:
receiving information as to a mobile device's current location;
processing, using a processor, the information of the mobile device's current location;
determining a plurality of locations of campaign providers relevant to a user of the mobile device, wherein one or more of the plurality of locations is participating in one or more promotional activities;
transmitting to the mobile device the plurality of locations of campaign providers;
receiving from the mobile device a selected location of a campaign provider from the plurality of locations of campaign providers;
receiving from the mobile device an action recorded on the mobile device at the selected location;
determining whether a promotional notification should be generated based on the recorded action;
in response to the determination, transmitting the promotional notification to the mobile device.

9. The method of claim 8, wherein the plurality of locations of campaign providers is determined based on the mobile device's current location.

10. The method of claim 8, wherein the determination for generating a promotional notification is based on attributes of a promotional campaign.

11. The method of claim 8, wherein the determination for generating a promotional notification is based on attributes of a user of the mobile device.

12. The method of claim 8, wherein the action recorded on the mobile device is a picture taken of a product available for sale at the selected location.

13. The method of claim 8, wherein the promotional notification is a digital coupon for use at the selected location.

14. A system for implementing digital promotions on a mobile device, comprising:
a processor;
a memory coupled to the processor, wherein the memory comprises program instructions executable by the processor for:
receiving on the mobile device a plurality of locations of campaign providers that are participating in one or more promotional activities;
presenting to a user of the mobile device the plurality of locations of campaign providers;
selecting, using the processor, a location from the plurality of locations of campaign providers;
recording an action on the mobile device at the selected location;
submitting the recorded action to a digital promotion engine capable of processing the action;
receiving at the mobile device a promotional notification from the digital promotion engine based on the recorded action.

15. The system of claim 14, further comprising a location sensor coupled to the processor and configured to infer a location of the mobile device.

16. The system of claim 14, further comprising a camera connected to the memory, wherein the action recorded on the mobile device is a pictured taken by the camera of a product available for sale at the selected location.

17. The system of claim 14, wherein the promotional sweepstakes involves a loyalty rewards program.

18. The system of claim 14, wherein the promotional sweepstakes involves a discount voucher program.

19. The system of claim 14, wherein the action recorded on the mobile device is the mobile device physically entering the premises of the selected location.

20. The system of claim 14, wherein the promotional notification is a digital coupon for use at the selected location.
